(19) United States
(12) Patent Application Publication
(10) Pub. No.: US 2008/0235642 A1
(43) Pub. Date: Sep. 25, 2008

(54) METHOD AND APPARATUS FOR LOCALIZED PLANNING IN AN INTEGRATED CIRCUIT

(75) Inventor: Ravikanth Tangirala, FREMONT, CA (US)

Correspondence Address: FRANKLIN (LIN) YANG, 91 CANTERBURY GATE, LYNBROOK, NY, 11563, US

(73) Assignee: LEGEND SILICON CORP., FREMONT, CA (US)

(21) Appl. No.: 11/687,678

(22) Filed: Mar. 19, 2007

(51) Int. Cl. G06F 17/50

(52) U.S. Cl. 716/8

(57) ABSTRACT

A method for an improved circuit design is provided. The method comprises the steps of: provide a core ring around a circumference of a circuit design; determining at least two stages of the circuit design; identifying a set of macros for at least one stage; and placing the set of macros within an area of the circuit.

### FIELD OF THE INVENTION

The present invention relates generally to integrated circuit design, more specifically the present invention relates to method and apparatus for localized floor planning in an integrated circuit.

### BACKGROUND

In integrated circuit design, typical the hard macros are placed in the proximity of the boundaries of the floor plan. The standard cells are placed around a center of the floor plan surrounded by macros.

However, when a clear and well defined interface exists between at least two sub-blocks in the design is not the optimum one. Therefore, there is a need for an improved, localized floor planning in an integrated circuit.

### SUMMARY OF THE INVENTION

A method for an improved circuit design is provided. The method comprises the steps of: provide a core ring around a circumference of a circuit design; determining at least two stages of the circuit design; identifying a set of macros for at least one stage; and placing the set of macros within an area of the circuit.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example circuit floor plan design in accordance with some embodiments of the invention.

FIG. 2 is an example of a power mesh in accordance with some embodiments of the invention.

FIG. 3 is an example of a flow chart in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to improved circuit floor plan with associated power mesh. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

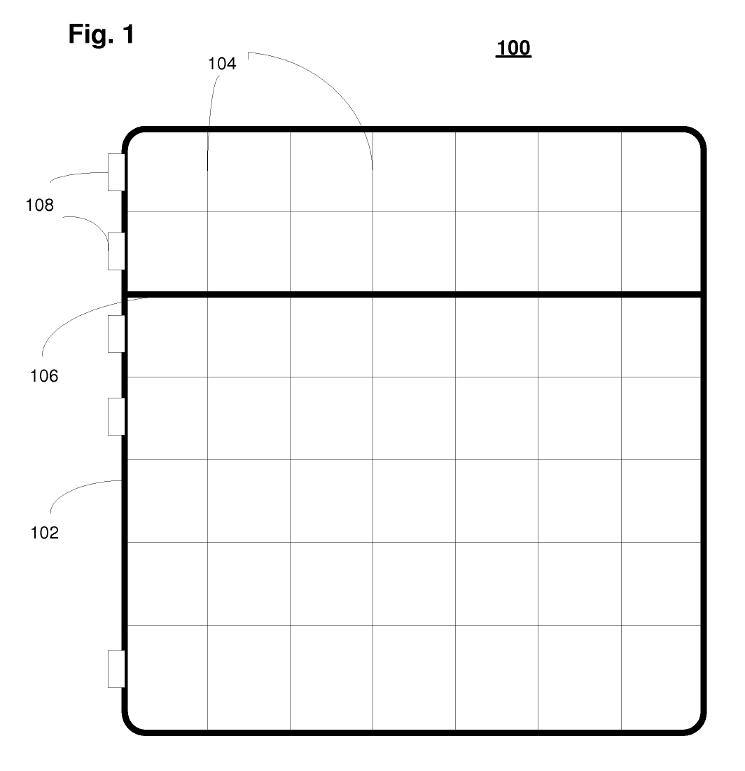

Referring to FIGS. 1-3, in FIG. 1 a circuit layout or a die 100 is provided. A core ring 102 formed circumferentially around the chip. Core ring 102 is coupled to an external power supply (not shown) and supplies power to circuit 100. typically, there are two core rings 102 (only one shown) for the circuit 100. One ring 102 has a higher voltage and the other ring has a relatively lower voltage, thereby completing the circuit. A power mesh having straps 104 connected to core ring 102 forms a network substantially covering the circuit 100. Straps 104 includes at least one thicker strap 106. Metal seats 108 (only a few shown) operate as the connection with the outside. Macros are distinguished between stages. For example, the n stage macros 110 and n+1 stage macros 112. Macros are memory blocks of circuit layout 100 that typically requires more power than other elements of the circuit 100. Other elements comprise logic gates, etc.

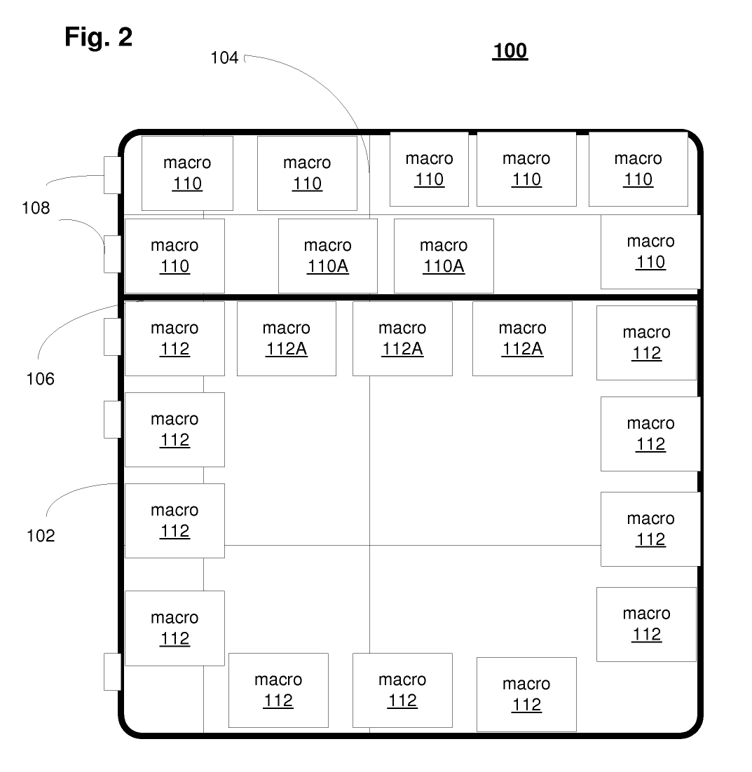

In FIG. 2 a demodulator 200 of a transceiver is formed within circuit 100. Two major stages are shown herein for demodulator 200. The two stages are demodulation stage and the forward error correction stage. The two stages have a clear and well defined interface. In this scenario the interface is shown to be between the front demodulation section (or demod) and Forward Error Correction section (or FEC). The interface between the modules is a data bus, a clock synchronized with the data, and a data valid signal. In other words, by using the interface disposed between the two stages or areas on the circuit or die 100, simplified circuit layout is achieved, as well as timing gains are realized. Regarding the timing gains, if complex circuit layout crossing stages is done, more difficulty results in the synchronization of the element in the die 100.

Most conventional tools for circuit 100 design do not take the interface into consideration. The typical known design of the prior art flattens at this juncture and causes the tools to run much longer and harder to place the standard cell, meet timing requirements and route same. Therefore increased die size results.

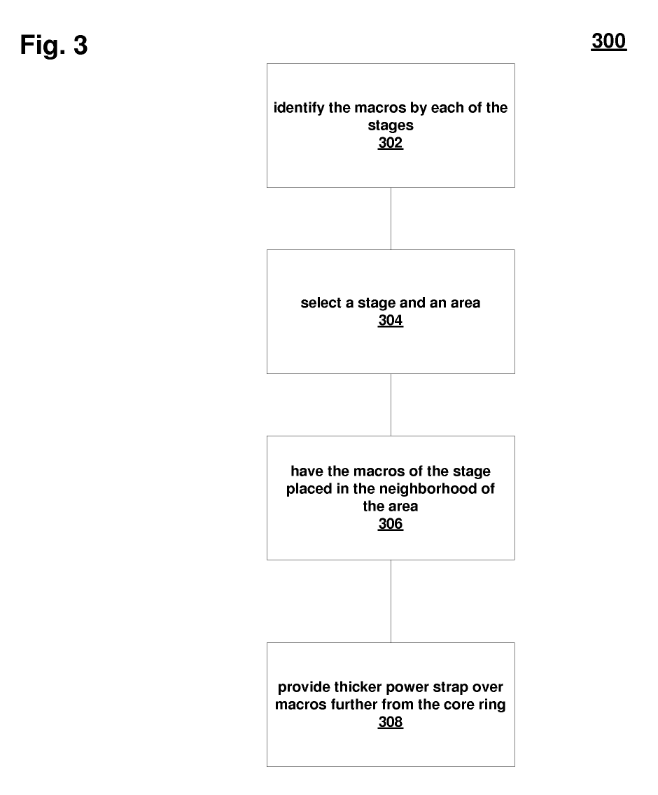

FIG. 3, a flow chart 300 depicting the implementation of the present invention is shown. Firstly the stages are identified. Then the macros that are associated to each of the stages are identified (Step 302). For each selected stage an area is designated within circuit 100 (Step 304). For example, the low density parity check (LDPC) stage and the forward error correction (FEC) stage. The selection of the amount of the area is done by using estimated area requirements for each stage. Since the macros of a stage consume more power, they are placed in the neighborhood of closer to core ring 102 in the area (Step 306). However, if it is impractical to place all the macros of the stage in the neighborhood closer to core ring 102 in the area, some macros necessarily are left further from the core ring 102 thereby cannot get sufficient power for normal operation. Therefore, once sufficient macros (macros 110 and macros 112) are ideally placed near or closer to the core ring 102 the remaining macros (macros 110A and macros 112A) are placed in a divider section in relation to both the sections such as the FEC section and the LDPC section. Then a thicker power strap 106 is provided over the divider section macros further from the core ring 102 (Step 308). The divider section is in a proximity of the thicker power strap 106. In other words, it is generally desirable to form or place the macros in the proximity of the core ring 102 for closer access to power. When it is impractical to place all the macros with a proximity of ring 102, the remaining macros, i.e. macros 110A and macros 112A are placed in the proximity of power line 106 for better access to power.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A method for an improved circuit design comprising the steps of:
provide a set of core ring around a circumference of a circuit design;
determining at least two stages of the circuit design;
physically separating elements of the at least two stages on the circuit design;
identifying a set of macros for at least one stage; and
placing the set of macros within an area of the circuit.

2. The method of claim 1 further comprising the step of providing a relatively thicker strap for macros of the stage if the macros are formed further from the core ring.

3. The method of claim 1 further comprising the step of providing a mesh of straps electrically coupled to the core ring.

4. The method of claim 1, wherein the core ring is electrically coupled to a power source.

5. The method of claim 1, wherein the circuit comprises a demodulator of a transceiver.
